(19) United States
(12) Patent Application Publication
(10) Pub. No.: US 2013/0216968 A1
(43) Pub. Date: Aug. 22, 2013

(54) APPARATUS FOR REFINING ORGANIC MATERIAL

(71) Applicants: Jung-Sub Lee, Yongin-city (KR); Seung-Gak Yang, Yongin-city (KR)

(72) Inventors: Jung-Sub Lee, Yongin-city (KR); Seung-Gak Yang, Yongin-city (KR)

(21) Appl. No.: 13/541,251

(22) Filed: Jul. 3, 2012

(30) Foreign Application Priority Data
Feb. 22, 2012 (KR) 10-2012-0017757

(51) Int. Cl. F27B 5/02

(52) U.S. Cl. 432/207

(57) ABSTRACT

An apparatus for refining an organic material includes an outer tube, a plurality of inner tubes in the outer tube and including at least one loading inner tube for loading an organic material to be refined and comprising a first loading boat and a second loading boat above the first loading boat in the loading inner tube, and at least one collecting inner tube for collecting refined organic material, a heating unit outside the outer tube, and a vacuum pump coupled to the outer tube for providing low pressure in the outer tube and the inner tubes.

### CROSS-REFERENCE TO RELATED APPLICATIONS

This application claims priority to and the benefit of Korean Patent Application No. 10-2012-0017757, filed on Feb. 22, 2012, with the Korean Intellectual Property Office, the disclosure of which is incorporated herein in its entirety by reference.

### BACKGROUND

1. Field

Embodiments of the present invention relate to an apparatus for refining an organic material.

2. Discussion of Related Art

An organic light emitting diode has a structure in which a plurality of organic thin film layers are laminated between a transparent positive electrode having a large work function, and a negative electrode having a small work function. When voltage is applied to the diode, holes are injected from the positive electrode to an organic layer, and electrons are injected from the negative electrode, such that the electrons and the holes are recombined in a light emitting layer to emit light.

One of the factors affecting light emitting characteristics of the organic light emitting diode is the level of purity of an organic material. If impurities are contained in the organic material, the impurities inhibit electron movement or result in dimming light, which reduces luminous intensity and luminous efficiency. Accordingly, to decrease the impurities, the organic material needs to be refined.

As a method for refining an organic material, recrystallization using a solvent, or recrystallization using sublimation, is generally used. The recrystallization using a solvent is advantageous in that it is possible to refine a large amount of organic material, but is disadvantageous in that the solvent is used, and thus, is easily introduced into organic crystals. In other words, there is a problem in that the solvent introduced into the organic crystals functions as an impurity, and thus, reduces light emitting characteristics. When manufacturing a diode using an organic material refined by a solvent, problems such as deterioration in degree of vacuum due to out-gassing and penetration of impurities into a thin film are caused.

On the other hand, in the recrystallization using sublimation, since the organic material is sublimated to be recrystallized in a vacuum, impurities are difficult to be introduced. Therefore, a sublimating and refining method is generally used for refining an organic material used for an organic light emitting diode. In a general method of sublimating and refining an organic material, a receptacle accommodating a sample and an inner tube for acquiring the organic material that is recrystallized may be used and an inert gas may be flowed.

However, the general method for refining an organic material requires a high temperature and extended time for refining, depending on the material, and the organic material may become decomposed due to the refining at a high temperature.

### SUMMARY

Embodiments of the present invention provide a refining apparatus that can refine more organic materials in a shorter unit time, and provide an apparatus for refining an organic material that can increase purity and yield, and can shorten a refining time by reducing or minimizing modification of the organic material under conditions of equivalent capacity and temperature.

An exemplary embodiment of the present invention provides an apparatus for refining an organic material, the apparatus including an outer tube, a plurality of inner tubes in the outer tube and including at least one loading inner tube for loading an organic material to be refined and comprising a first loading boat and a second loading boat above the first loading boat in the loading inner tube, and at least one collecting inner tube for collecting refined organic material, a heating unit outside the outer tube, and a vacuum pump coupled to the outer tube for providing low pressure in the outer tube and the inner tubes.

The vacuum pump may be closer to the collecting inner tube than the loading inner tube.

The loading inner tube may be open at a side adjacent the vacuum pump and may be sealed at an opposite side.

The first loading boat and the second loading boat may each include plane-shaped base portions and side walls at ends of the base portions.

The first loading boat and the second loading boat may each include a plane-shaped base portion and a side wall at an end of the base portion adjacent the vacuum pump.

A distance between an end of the side wall of the first loading boat and the base portion of the second loading boat may be about 10 to 200 mm.

A distance between the first loading boat and the second loading boat may be about 20 to 200 mm.

The loading inner tube may include a first supporting unit for supporting the first loading boat, and a second supporting unit for supporting the second loading boat.

At least one of the first supporting unit or the second supporting unit may have a protruding shape.

At least one of the first supporting unit or the second supporting unit may have a slit shape for accommodating a side surface of a base portion of a corresponding one of the first and second loading boats.

The heating unit may include two or more heating devices separated along the outer tube.

The two or more heating devices may be configured to respectively provide different heating temperatures.

The apparatus may further include a connection portion coupling two or more of ones of the plurality of inner tubes.

The vacuum pump may be configured to cause an internal pressure of the outer tube to be 10⁻⁵ Pa to 100 Pa.

The apparatus may further include a resublimating inner tube between the loading inner tube and the collecting inner tube.

The resublimating inner tube may be for resublimating the organic material, wherein the apparatus is configured to enable the organic material to be sublimated in the loading inner tube, discharged from the loading inner tube, and then crystallized.

The organic material may be for manufacturing an organic light emitting diode.

The organic material may include at least one of an organic material for forming a light emitting layer, an organic material for forming a hole injection layer, an organic material for forming a hole transporting layer, an organic material for forming an electron injection layer, or an organic material for forming an electron transporting layer.

The organic material to be refined may have a molecular weight in a range of 500 to 2,000.

According to an exemplary embodiment of the present invention, it is possible to improve yield and shorten a refining time when refining an organic material.

The foregoing summary is intended to be illustrative only, and is not intended to be limiting in any way. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating a structure of a general apparatus for refining an organic material, according to an embodiment of the present invention.

FIG. 2 is a structure diagram schematically illustrating a main part of the general apparatus for refining an organic material, according to the embodiment shown in FIG. 1.

FIG. 3 is a diagram illustrating a general structure of a first inner tube in the general apparatus for refining an organic material in detail, according to the embodiment shown in FIG. 1.

FIG. 4 is a structure diagram schematically illustrating an apparatus for refining an organic material, according to an exemplary embodiment of the present invention.

FIG. 5 is a diagram illustrating a first inner tube of the apparatus for refining an organic material, according to an exemplary embodiment of the present invention in detail.

FIG. 6 is a perspective view illustrating a first inner tube of the apparatus for refining an organic material according to an exemplary embodiment of the present invention.

FIGS. 7A and 7B illustrate an example of a loading boat of an apparatus for refining an organic material according to an exemplary embodiment of the present invention.

### DETAILED DESCRIPTION

Hereinafter, exemplary embodiments of the present invention will be described in detail with reference to the accompanying drawings.

The embodiments of the present invention may be modified in various forms, and only specific exemplary embodiments are shown in the drawings, and will be described representatively below. However, the scope of the present invention is not limited to the specific exemplary embodiments, and should be construed as including all the changes, equivalents, and substitutions included in the spirit and scope of the present invention.

Terms used herein are general terms that are widely used. In some cases, however, terms selected at the applicant's discretion are also used, and the meanings thereof should be comprehended in consideration of the meanings described or used in the detailed description of the present invention.

In order to elucidate the present invention, parts that do not relate to the description are omitted, and like reference numerals designate like elements throughout the specification. In the drawings, the size and the thickness of each element may be arbitrarily represented for ease of description, and the present invention is not limited to the dimensions shown in the drawings. Further, in the drawings, the thicknesses of layers, regions, etc., may be exaggerated for clarity and/or ease of description. It will be understood that when an element such as a layer, film, region, or substrate is referred to as being “on” another element, it can be directly on the other element, or one or more intervening elements may also be present.

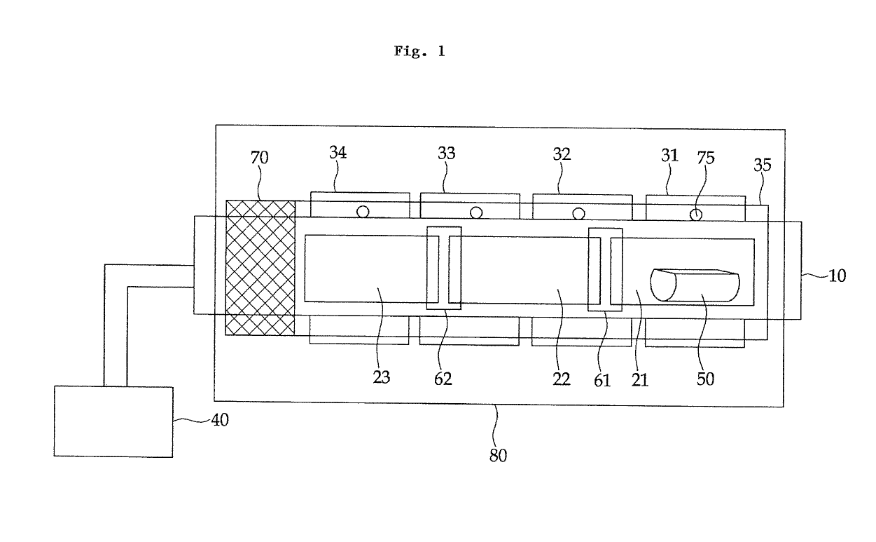

FIG. 1 illustrates a general apparatus for refining an organic material, according to an embodiment of the present invention. Referring to FIG. 1, FIG. 1 shows the apparatus for refining an organic material includes a receptacle 50, which is for generally accommodating an organic material to be refined, a plurality of inner tubes 21, 22, and 23 for separating the refined organic material from impurities, connection portions 61 and 62 coupling the plurality of inner tubes 21, 22, and 23, an outer tube 10 accommodating the plurality of inner tubes 21, 22, and 23 coupled to each other in series and positioned inside a plurality of heaters 31, 32, 33, and 34, the plurality of heaters 31, 32, 33, and 34 for applying heat to the outer tube 10 and the inner tubes 21, 22, and 23, and a heat conduction tube 35 positioned between the outer tube 10 and the plurality of heaters 31, 32, 33, and 34 and for conducting heat generated from the heaters.

The heaters 31, 32, 33, and 34 may heat the inner tubes 21, 22, and 23 at different temperatures. The apparatus for refining an organic material of the present embodiment includes a temperature sensor 75 in, at, or near the heat conduction tube 35 to sense a temperature of the outer tube 10, a cooling portion 70 with a cooling line at or near an end portion of the metal tube 10 to cool the inner tubes 21, 22, and 23, and a vacuum pump 40 for maintaining a vacuum in the outer tube 10.

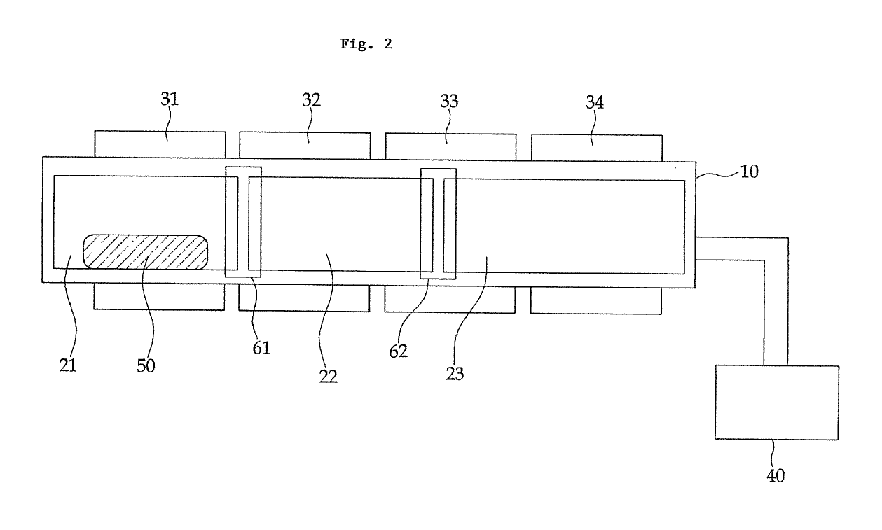

FIG. 2 is a structure diagram schematically illustrating a configuration of the general apparatus for refining an organic material of the embodiment shown in FIG. 1, and for better understanding, only main parts of the refining apparatus are schematically shown.

The configuration of the outer tube 10, the inner tubes 21, 22, and 23, the heaters 31, 32, 33, and 34, the vacuum pump 40, the receptacle 50, and the connection portions 61 and 62 are the same as described above.

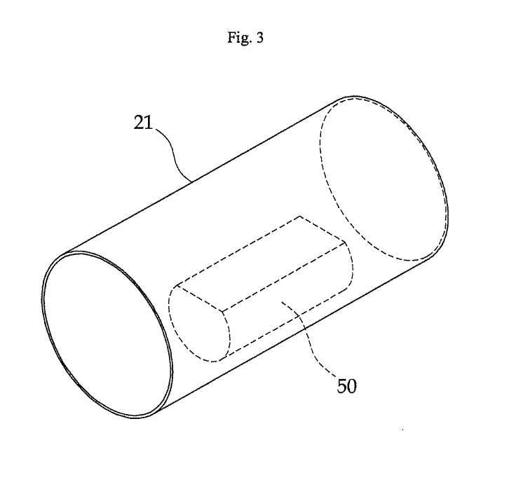

FIG. 3 is a diagram illustrating a first inner tube 21 including the receptacle 50 therein among the plurality of inner tubes 21, 22, and 23 shown in FIGS. 1 and 2 in detail.

Referring to FIGS. 2 and 3, in the general refining apparatus of the present embodiment, the plurality of inner tubes 21, 22, and 23 are located inside the outer tube 10 and coupled to each other by the connection portions 61 and 62. The plurality of inner tubes 21, 22, and 23 are heated at different temperatures so that the refined organic material and impurities are separated, and the receptacle 50 is mounted in one of the plurality of inner tubes 21, 22, and 23.

In the apparatus for refining an organic material of the present embodiment, an organic material to be refined is loaded in the receptacle 50 inside the first inner tube 21. In this case, as shown in FIG. 3, since the organic material is loaded in only a lower end of the receptacle 50, an amount of the loaded organic material is limited, and heat transferred to the organic material positioned at a lower end portion of the loading portion and at a location close to the heater, and to the organic material that is positioned at a central part, is not uniform. The organic material located at the location close to the heater may be relatively modified due to thermal stress that is applied continuously for the refining time.

As described above, in the case of using the refining apparatus of the present embodiment, the thermal stress applied to the organic material is increased, which may negatively affect the purity and yield of the organic material.

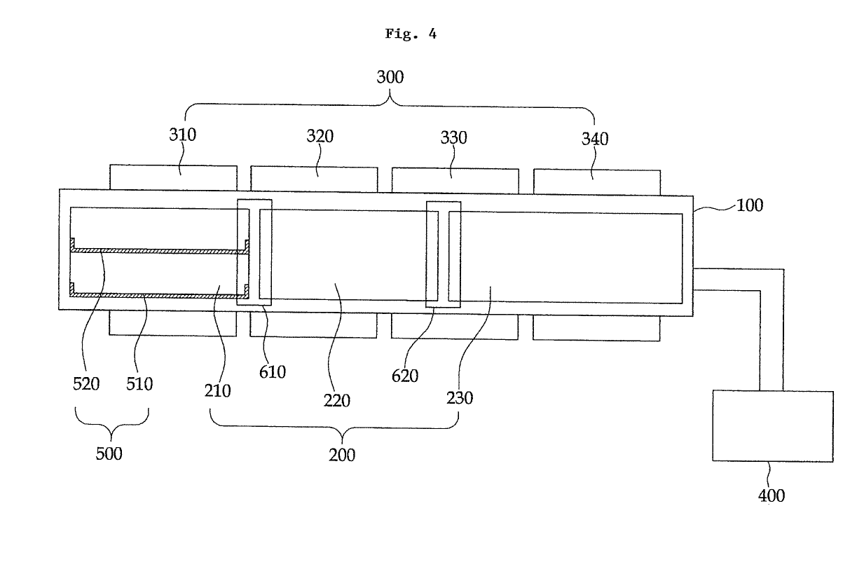

An exemplary embodiment of the present invention provides an apparatus for refining an organic material as shown in FIG. 4. Hereinafter, a structure of the apparatus for refining an organic material according to an exemplary embodiment of the present invention will be described.

FIG. 4 is a schematic view showing the apparatus for refining an organic material according to an exemplary embodiment of the present invention, and the apparatus for refining an organic material according to the present exemplary embodiment includes an outer tube 100 formed in a hollow tube shape; a plurality of inner tubes 200 located in the outer tube; a heating unit 300 located outside the outer tube; and a vacuum pump 400 coupled to the outer tube to provide a low-pressure state in the outer tube and the inner tubes.

The inner tubes 200 include a plurality of inner tubes 210, 220, and 230, which are coupled to each other via connection portions 610 and 620 inside the outer tube 100. As a result, the inner tubes 210, 220, and 230 may be separated from each other when the organic material is loaded and after refining work is completed. In the present exemplary embodiment, the two connection portions 610 and 620 are shown, but, according to other embodiments of the present invention, the number of connection portions may vary depending on the number of inner tubes.

The plurality of inner tubes 200 of the present embodiment includes at least one loading inner tube 210 for loading an organic material to be refined, and at least one collecting inner tube 230 for collecting the refined organic material.

According to the present exemplary embodiment, the vacuum pump 400 is located closer to the collecting inner tube 230 than the loading inner tube 210. A resublimating inner tube 220 may be located between the loading inner tube 210 and the collecting inner tube 230. The resublimating inner tube 220 is for filtering out high-temperature impurities and for preventing low-temperature impurities from being included in the refined organic material after the organic material is sublimated in the loading inner tube 210.

At least one surface of the loading inner tube 210 may be opened or sealed (e.g., enclosed). In the present exemplary embodiment, the loading inner tube 210 is open at a side adjacent the vacuum pump 400 side and sealed at an opposite side of the vacuum pump 400. By doing this, some of the organic material flowing outside the loading inner tube 210 is blocked by a sealing surface formed at one side of the loading inner tube, and thus, flows back to the vacuum pump side. Accordingly, it is possible to reduce or minimize the organic material that is crystallized on the sealing surface, thus contributing to improvement in yield.

Meanwhile, the heating unit 300 may include two or more individual heating devices that are separated along the outer tube 100, and in the present exemplary embodiment, the heating unit 300 including four heating devices 310, 320, 330, and 340 is described as an example. The respective heating devices 310, 320, 330, and 340 are heated to the same temperature or to different temperatures to maintain the temperature of the plurality of inner tubes equally or differently.

The vacuum pump 400 is for creating a low-pressure state in the outer tube 100 and the inner tubes 210, 220, and 230. A kind of vacuum pump is not particularly limited. According to an exemplary embodiment of the present invention, a vacuum pump 400 with a capacity to allow the internal pressure of the outer tube 100 to be 10⁻⁵ Pa to 100 Pa may be used.

In this configuration, the organic material that is sublimated in the loading inner tube 210 by operating the heating unit 300 is moved to the collecting inner tube 230 via the resublimating inner tube 220 by driving the vacuum pump 400, and the organic material is then collected after crystallization. In this case, some of the organic material may be crystallized in the resublimating inner tube 220. The organic material, which is crystallized in the resublimating inner tube 220, is moved to the collecting inner tube 230 by heating, and is crystallized in the collecting inner tube 230 that is heated to a temperature different from that of the loading inner tube 210. After all the processes are completed, the crystallized organic material is recovered in the collecting inner tube 230 to be used.

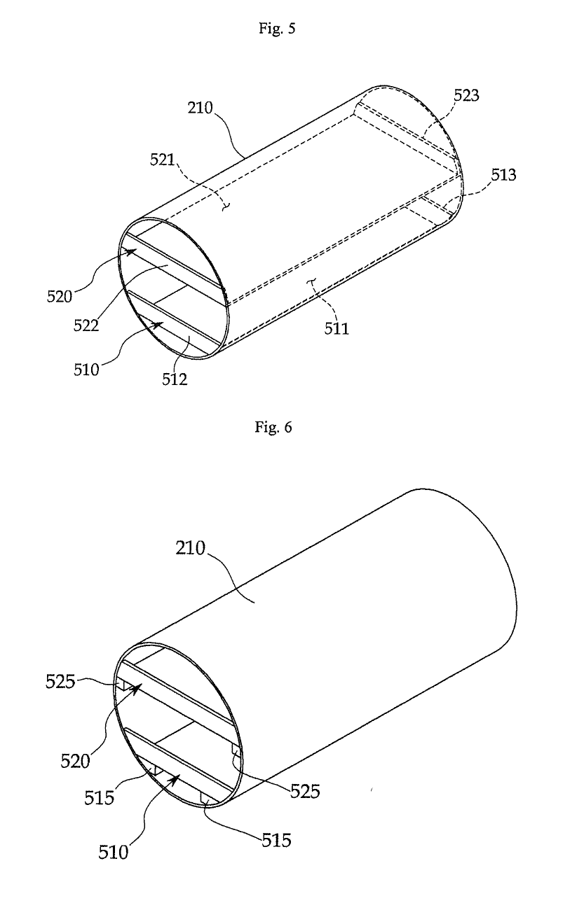

FIG. 5 is a diagram illustrating an example of the loading inner tube 210 of the apparatus for refining an organic material, according to an exemplary embodiment of the present invention in detail.

The loading inner tube 210 includes a first loading boat 510 and a second loading boat 520 for loading an organic material to be refined and as shown in FIG. 5, the second loading boat 520 is located above the first loading boat 510 in the loading inner tube.

The first loading boat 510 and the second loading boat 520 may have a configuration including plane-shaped base portions 511 and 521 and side walls 512, 513, 522, and 523 located at ends of the base portions 511 and 521.

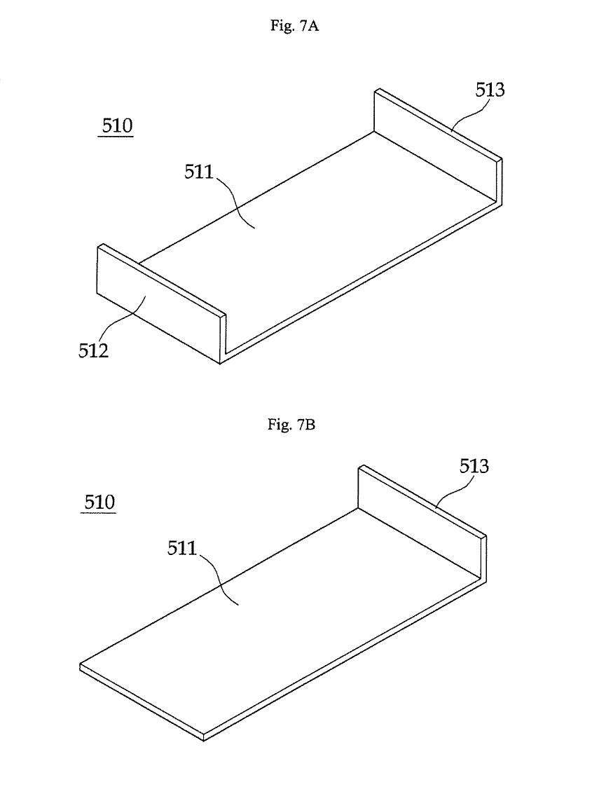

FIGS. 7A and 7B schematically illustrate examples of the first loading boat 510.

Referring to FIG. 7A, the first loading boat 510 includes a plane-shaped base portion 511 and side walls 512 and 513 located at ends of the base portion 511. According to embodiments of the present invention, a single side wall (e.g., 513) may be located at only one side of the base portion 511. In other words, in the case where an opposite side of the vacuum pump 400 is sealed, as shown in FIG. 7B, only one side wall 513 might be located at a vacuum pump 400 side end of the base portion 511, while the side wall 512 located at an end at the opposite side of the vacuum pump 400, which is a sealing surface, may be omitted.

FIGS. 7A and 7B illustrate an example of the first loading boat 510, but the second loading boat 520 may have the same configuration. In other words, as shown in FIG. 5, the second loading boat 520 may include a plane-shaped base portion 521 and side walls 522 and 523 located at ends of the base portion. In the case where an opposite side of the vacuum pump 400 is sealed, only one side wall 523 may be located at a vacuum pump 400 side end of the base portion 521, and the side wall 522 located at an end at the opposite side of the vacuum pump 400, which is a sealing surface, may be omitted.

The first loading boat 510 and the second loading boat 520 of the present embodiment are included in the loading inner tube 210, and the second loading boat 520 is located above the first loading boat 510. Alternatively, according to other embodiments of the present invention, the first loading boat 510 may be located above the second loading boat 520.

In the present exemplary embodiment, the first loading boat 510 and the second loading boat 520 are configured such that a distance between the first loading boat 510 and the second loading boat 520 is 20 to 200 nm, and distances between ends of the side walls 512 and 513 of the first loading boat 510 and the base portion 521 of the second loading boat 520 are 10 to 200 nm. When the distances are very small, there are difficulties in transferring heat and flowing the sublimated organic material, while when the distances are very large, spatial utilization of the inner tube is reduced, and the respective loading boats become closer to the heating devices, and as a result, thermal stress may be applied to the organic material loaded on the loading boat.

In the present exemplary embodiment, to support the first loading boat 510 and the second loading boat 520 in the loading inner tube 210, the loading inner tube 210 may include a first supporting unit and a second supporting unit.

FIG. 6 is a perspective view illustrating the loading inner tube 210 of the apparatus for refining an organic material according to an exemplary embodiment of the present invention.

In the exemplary embodiment, at least one of the first supporting unit 515 and the second supporting unit 525 may include protruding portions as shown in FIG. 6. In this case, the base portion 511 of the loading boat 510 or 520 may be supported by the protruding portions.

As another example, the supporting unit may have a slit shape. For example, when the loading boat 510 or 520 has the configuration as shown in FIG. 7B in which only one side surface of the base portion is formed, the loading boat 510 or 520 is inserted into a slit through the one side surface of the loading boat 510 to be supported. The first loading boat 510 and the second loading boat 520 may be configured in various shapes as long as the first loading boat 510 and the second loading boat 520 are supported in the loading inner tube 210.

As shown in FIG. 6, in the refining apparatus according to an exemplary embodiment of the present invention, since the organic material to be refined is divided and loaded on the first loading boat 510 and the second loading boat 520, the loading capacity may be increased. In the case of equivalent capacity, since the organic material is widely spread and loaded, heat is evenly transferred, thereby shortening the refining time. By shortening the refining time, the modification of the organic material is reduced, thus improving the purity of collected organic material.

In the exemplary embodiment, the organic material to be refined includes an organic material used for manufacturing an organic light emitting diode, and examples thereof may include an organic material for forming a light emitting layer, an organic material for forming a hole injection layer, an organic material for forming a hole transporting layer, an organic material for forming an electron injection layer, and an organic material for forming an electron transporting layer.

A range of a molecular weight of the organic material to be refined is not particularly limited. According to an exemplary embodiment of the present invention, the molecular weight of the organic material may be in the range of 500 to 2,000.

When the molecular weight of the organic material to be refined is less than 500, the yield of the apparatus for refining an organic material according to the present exemplary embodiment is not significantly reduced. However, since the organic material is sublimated at a relatively low temperature and activity of the sublimated organic material is increased, the inner tube may need to be very long, or a large number of inner tubes may need to be used.

In contrast, when the molecular weight of the organic material exceeds 2,000, there may be a wide variation in the molecular weights of the organic materials, and high heat is required to sublimate the organic materials having large molecular weights. In this case, thermal efficiency may be reduced, and thermal stress due to the high heat may be applied to the organic material.

As described above, when the apparatus for refining an organic material according to an exemplary embodiment of the present invention is used, it is possible to shorten the refining time and to improve the purity and yield of the organic material by dividing and loading the organic material so as to comparatively evenly transfer the heat to the organic material to be refined.

In the present disclosure, the apparatus for refining an organic material used for manufacturing an organic light emitting diode has been described as an example, but the scope of the present invention is not limited thereto.

From the foregoing, it will be appreciated that various embodiments of the present invention have been described herein for purposes of illustration, and that various modifications may be made without departing from the scope and spirit of the present invention. Accordingly, the various embodiments disclosed herein are not intended to be limiting, with the true scope and spirit being indicated by the following claims, and their equivalents.

What is claimed is:

1. An apparatus for refining an organic material, the apparatus comprising:
an outer tube;
a plurality of inner tubes in the outer tube and comprising:
at least one loading inner tube for loading an organic material to be refined and comprising a first loading boat and a second loading boat above the first loading boat in the loading inner tube; and
at least one collecting inner tube for collecting refined organic material;
a heating unit outside the outer tube; and
a vacuum pump coupled to the outer tube for providing low pressure in the outer tube and the inner tubes.

2. The apparatus for refining an organic material of claim 1, wherein the vacuum pump is closer to the collecting inner tube than the loading inner tube.

3. The apparatus for refining an organic material of claim 1, wherein the loading inner tube is open at a side adjacent the vacuum pump and is sealed at an opposite side.

4. The apparatus for refining an organic material of claim 1, wherein the first loading boat and the second loading boat each comprise plane-shaped base portions and side was at ends of the base portions.

5. The apparatus for refining an organic material of claim 1, wherein the first loading boat and the second loading boat each comprise a plane-shaped base portion and a side wall at an end of the base portion adjacent the vacuum pump.

6. The apparatus for refining an organic material of claim 5, wherein a distance between an end of the side wall of the first loading boat and the base portion of the second loading boat is about 10 to 200 mm.

7. The apparatus for refining an organic material of claim 1, wherein a distance between the first loading boat and the second loading boat is about 20 to 200 mm.

8. The apparatus for refining an organic material of claim 1, wherein the loading inner tube comprises:
a first supporting unit for supporting the first loading boat; and
a second supporting unit for supporting the second loading boat.

9. The apparatus for refining an organic material of claim 8, wherein at least one of the first supporting unit or the second supporting unit has a protruding shape.

10. The apparatus for refining an organic material of claim 8, wherein at least one of the first supporting unit or the second supporting unit has a slit shape for accommodating a side surface of a base portion of a corresponding one of the first and second loading boats.

11. The apparatus for refining an organic material of claim 1, wherein the heating unit comprises two or more heating devices separated along the outer tube.

12. The apparatus for refining an organic material of claim 11, wherein the two or more heating devices are configured to respectively provide different heating temperatures.

13. The apparatus for refining an organic material of claim 1, the apparatus further comprising:
a connection portion coupling two or more of ones of the plurality of inner tubes.

14. The apparatus for refining an organic material of claim 1, wherein the vacuum pump is configured to cause an internal pressure of the outer tube to be 10⁻⁵ Pa to 100 Pa.

15. The apparatus for refining an organic material of claim 1, the apparatus further comprising a resublimating inner tube between the loading inner tube and the collecting inner tube.

16. The apparatus for refining an organic material of claim 15, wherein the resublimating inner tube is for resublimating the organic material, wherein the apparatus is configured to enable the organic material to be sublimated in the loading inner tube, discharged from the loading inner tube, and then crystallized.

17. The apparatus for refining an organic material of claim 1, wherein the organic material is for manufacturing an organic light emitting diode.

18. The apparatus for refining an organic material of claim 17, wherein the organic material comprises at least one of an organic material for forming a light emitting layer, an organic material for forming a hole injection layer, an organic material for forming a hole transporting layer, an organic material for forming an electron injection layer, or an organic material for forming an electron transporting layer.

19. The apparatus for refining an organic material of claim 1, wherein the organic material to be refined has a molecular weight in a range of 500 to 2,000.
